(19) United States
(12) Patent Application Publication
(10) Pub. No.: US 2015/0288640 A1
(43) Pub. Date: Oct. 8, 2015

(54) METHOD AND DEVICE FOR PROVIDING NOTIFICATION

(71) Applicant: Samsung Electronics Co., Ltd., Gyeonggi-do (KR)

(72) Inventor: Chang Han LEE, Gyeonggi-do (KR)

(73) Assignee: Samsung Electronics Co., Ltd.

(21) Appl. No.: 14/678,150

(22) Filed: Apr. 3, 2015

(30) Foreign Application Priority Data
Apr. 3, 2014 (KR) 10-2014-0039843

(51) Int. Cl. H04L 12/58; G06F 9/54

(52) U.S. Cl. CPC H04L 51/24; G06F 9/542

(57) ABSTRACT

A method of providing a notification by an electronic device is provided. The method includes initializing a first timer and a second timer that operate to control the notification; sensing at least one event; determining whether to restrict the notification of the at least one event based on a comparison of an occurrence time of the at least one event to a state of the second timer; and when the first timer expires, providing the notification of the at least one event which occurred after the initialization of the first timer and of which the notification is restricted by the second timer.

### PRIORITY

This application claims priority under 35 U.S.C. §119(a) to a Korean Patent Application filed on Apr. 3, 2014 and assigned Serial No. 10-2014-0039643, the entire contents of which are incorporated herein by reference.

### BACKGROUND

1. Field of the Invention

The present invention relates generally to a method and device for providing notification to a user by an electronic device,

2. Description of the Related Art

Users may use electronic devices (such as smart phones, tablets or Personal Computers (PCs)) to transmit and receive messages to and from other users. R is also possible to receive notification of an e-mail, an instant message using a chatting program, or a message via a social network application such as Facebook or Twitter, in addition to Short Message Service (SMS) or Multimedia Message Service (MMS). In addition, due to the various and smart functions of electronic devices, various applications and services may be provided to users via the electronic devices. In particular, chatting applications may provide a group chatting function that enables messages to be shared with many people.

Since group chatting using an application enables many people to transmit messages simultaneously, many notifications may be provided in a short time. For example, messages may be exchanged many times within a minute in the case of an active chat group. In this case, an electronic device provides a user with message notifications many times, thus so many notifications may cause inconveniency in circumstance where such notifications are not wanted (e.g., in a circumstance where a user or other people around the electronic device may experience the notification when a user does not want to or cannot, check the notification, when a user leaves his or her seat without his or her electronic device, when a user does not check messages for a substantial amount of time, etc.).

### SUMMARY

The present invention has been made to address the above mentioned problems and disadvantages, and to provide at least the advantages described below. Accordingly, as aspect of the present invention provides a method and apparatus for providing notification that effectively provides notification through a control by an electronic device and prevents a user from experiencing unnecessary stress.

According to an aspect of the present invention, a method of providing a notification by an electronic device is provided. The method includes initializing a first timer and a second timer that operate to control the notification; sensing at least one event; determining whether to restrict the notification of the at least one event based on a comparison of an occurrence time of the at least one event to a state of the second timer; and when the first timer expires, providing the notification of the at least one event which occurred after the initialization of the first timer and of which the notification is restricted by the second timer.

According to another aspect of the present invention, an electronic device providing a notification of at least one event is provided. The electronic device includes a control unit configured to initialize a first timer and a second timer that operate to control the notification; an event sensing unit configured to sense an occurrence of the at least one event; and a notification unit configured to provide the notification of the at least one event, wherein the control unit is further configured to control the notification unit to provide the notification of at least one notification-restricted event by the second timer among the at least one event that has occurred after the initialization of the first timer, when the first timer expires.

According to another aspect of the present invention, a method of providing a notification by an electronic device is provided. The method includes initializing a timer operating to control the notification, sensing an occurrence of at least one event; and if the at least one event exceeds a number of times within a designated time after the initialization of the timer, restricting the notification of the at least one event.

### BRIEF DESCRIPTION OF THE DRAWINGS

The above and other aspects, features, and advantages of the present invention will be more apparent from the following detailed description, taken in conjunction with the accompanying drawings, in which:

FIG. 1 is a schematic diagram of an electronic device according to an embodiment of the present invention;

FIG. 2 is an illustration of a message notification based on a time when a message is received from when a timer is initialized according to embodiments of the present invention;

FIG. 3 is an illustration of a message notification according to an initialization of a short timer according to embodiments of the present invention;

FIG. 4 is an illustration of a message notification according to an expiration of a long timer according to embodiments of the present invention;

FIG. 5 is an illustration of a message notification according to an expiration of a long timer before an expiration of a short timer according to embodiments of the present invention;

FIG. 6 is an illustration where a timer is initialized in response to a notification of a message according to embodiments of the present invention;

FIG. 7 is an illustration where a timer is initialized in response to an expiration of a long timer according to embodiments of the present invention;

FIG. 8 is an illustration of a message notification method according to embodiments of the present invention;

FIG. 9 is an illustration of a message notification method according to embodiments of the present invention;

FIG. 10 is a flowchart of a message notification method according to an embodiment of the present invention;

FIG. 11 is a flowchart of a message notification method based on an expiration of a second timer according to an embodiment of the present invention;

FIG. 12 is a flowchart of a message notification method based on an activation of a timer according to an embodiment of the present invention;

FIG. 13 is a flowchart of a cycle change method of a second timer according to an embodiment of the present invention;

FIG. 14 is an illustration of a timer setting interface according to embodiments of the present invention; and

FIG. 15 is a block diagram of an electronic device according to an embodiment of the present invention.

### DETAILED DESCRIPTION OF EMBODIMENT OF THE PRESENT INVENTION

Various embodiments of the present invention are described below in conjunction with the accompanying drawings. Since various modifications of the embodiments of the present invention may be made, certain embodiments of the present invention are illustrated in the drawings and related detailed descriptions are disclosed herein. However, the present invention is not intended to be limited to certain embodiments and it should be understood that the present invention covers all modifications, equivalents, and/or replacements that fall within the scope and spirit of the present invention. In describing the drawings, similar components are denoted via the use of similar reference numerals.

The expressions “include” and “may include” that may be used in this disclosure indicates the presence of a disclosed corresponding function, operation or component, but does not exclude one or more additional functions, operations or components. Furthermore, it should be understood that the terms “includes” and “has” in this disclosure indicates the presence of characteristics, numbers, steps, operations, components, parts or combinations thereof represented in the present invention but do not exclude the presence or addition of one or more other characteristics, numbers, steps, operations, components, parts or combinations thereof.

The expression “or” in this disclosure includes any and all combinations of words enumerated together with the expression. For example, the expression “A or B” may include A, B, or both A and B.

The expressions “a first,” “a second,” “firstly,” or “secondly” in this disclosure may modify various components of various embodiments of the present invention but do not limit corresponding components. For example, the expressions above do not limit the order and/or importance of corresponding components. The expressions above may be used to distinguish one component from another. For example, both a first user device and a second user device are user devices that are mutually different user devices. For example, without departing from the scope or spirit of the present invention, a first component may be referred to as a second component and similarly, a second component may also be referred to as a first component.

When it is mentioned that any component is “connected to” or “accessed by” another component, it should be understood that the former can be directly connected to the latter, or there may be another component in between. On the contrary, when it is mentioned that any component is “directly connected to” or “directly accessed by” another component, it should be understood that there is no other component in between.

The terms used in this disclosure are used only to describe embodiments of the present invention and are not intended to limit the embodiments of the present invention. The terms in singular form include the plural form unless otherwise specified.

Unless otherwise defined herein, all terms used herein including technical or scientific terms have the same meanings as those generally understood by a person skilled in the art to which the various embodiments of the present invention pertain. Terms used herein that are defined in generally used dictionaries should be construed to have meanings matching contextual meanings in the related art and should not be construed as having an ideal or excessively formal meaning unless otherwise defined herein.

An electronic device according to an embodiment of the present invention is a device that includes a notification function. For example, the electronic device includes at least one of a smart phone, a tablet Personal Computer (PC), a mobile phone, a video phone, an e-book reader, a desktop PC, a laptop PC, a net book computer, a Personal Digital Assistant (PDA), a Portable Multimedia Player (PMP), a Moving Picture Experts Group Audio Layer 3 (MP3) player, a mobile medical device, a camera, and a wearable device (e.g., a Head-Mounted-Device (HMD) such as electronic glasses, electronic clothing, an electronic bracelet, an electronic necklace, an electronic appcessory, an electronic tattoo, or a smart watch).

According to an embodiment of the present invention, the electronic device may be a smart home appliance having a notification function. The smart home appliance may include, for example, at least one of a TV, a Digital Video Disc (DVD) player, an audio set, a refrigerator, an air conditioner, a cleaner, an oven, a microwave oven, a washing machine, an air cleaner, a set-top box, a TV box (e.g. Samsung HomeSync™, Apple TV™, or Google TV™), a game console, an electronic dictionary, an electronic key, a camcorder, and an electronic frame.

According to an embodiment of the present invention, the electronic device may include at least one of various medical devices (e.g., a Magnetic Resonance Angiography (MRA) device, a Magnetic Resonance Imaging (MRI) device, a Computed Tomography (CT) device, a camera, and an ultrasonicator), a navigator, a Global Positioning System (GPS) receiver, an Event Data Recorder (EDR), a Flight Data Recorder (FDR), a car infotainment device, electronic equipment for a ship (e.g., a navigator for a ship or a gyro compass), avionics, a security device, a head unit for a car, an industrial or home robot, a financial institution's Automated Teller Machine (ATM) or a store's Point of Sale (POS) system, which has a notification function. According to an embodiment of the present invention, the electronic device may include at least one of a portion of a building/structure or furniture including a communication function, an electronic board, an electronic signature receiving device, a projector, and various measurement devices (e.g., a water, electricity, gas or electric wave measurement device), which have a notification function. According to an embodiment of the present invention, the electronic device may be one or a combination of the above-described various devices. Moreover, electronic devices according to embodiments of the present invention may be flexible devices. Moreover, it is obvious to a person skilled in the art that electronic devices according to embodiments of the present invention are not limited to the above-described devices.

In embodiments of the present invention described herein, an “event” is not limited to a typical SMS or MMS message. An event refers to any information that is provided to a user of an electronic device, and “event notification” refers to notification of the reception or generation of the information. For example, notification of a text message received by an electronic device may be provided to a user. Also, notification of mail received by a user's mail account (such as Outlook, Gmail, Microsoft (MS) Exchange, other portal service or business account) registered or synchronized with an electronic device may be provided to the user. Notification of a text, image, emoticon, hyperlink and moving picture received via various chat applications such as Facebook messenger, Circle, KakaoTalk, Never Line, and Samsung ChatOn. Notification of various events, for example a new comment, a new friend request, user tagging, friend request acceptance, a membership application, and membership application acceptance, that may be provided by a Social Network Service (SNS) such as Facebook, Twitter, or LinkedIn, may be provided to the user.

The notification is not limited to occurring in response to a received event. The notification may include notification that an electronic device autonomously generates. For example, notification of a received text message or a missed call may be provided to a user many times. For example, when a message is received, a first notification may be provided and after a minute elapses without the message being checked, another notification may be provided. In this case, the first notification occurs in response to a received event, and the other notification occurs according to an autonomously defined condition.

Below, an example of receiving messages many times is described for the convenience of description. However, in some embodiments of the present invention, a message or message notification may be described or understood as a comprehensive concept as described above.

Below, electronic devices according to various embodiments of the present invention are described with reference to the accompanying drawings. The term “user” used in the present invention may indicate a person who uses an electronic device, or a device (e.g., an artificial-intelligence electronic device) that uses the electronic device.

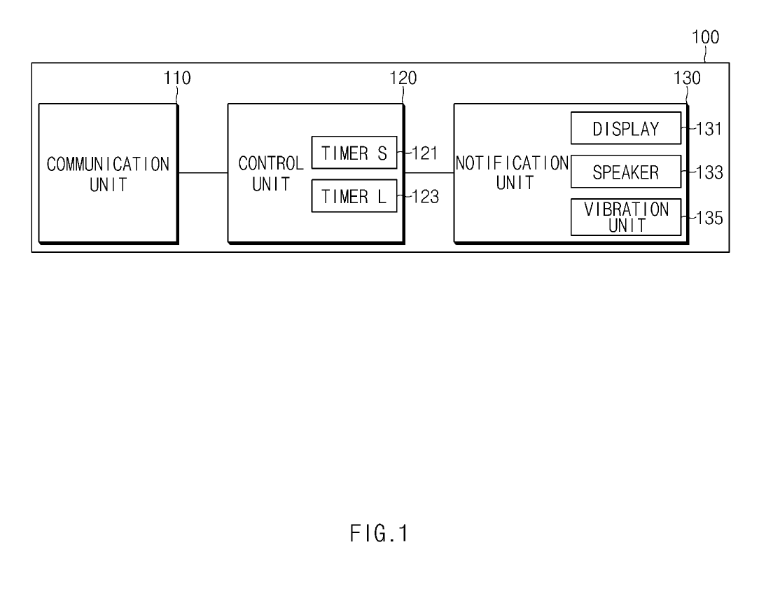

FIG. 1 is a schematic diagram of an electronic device 100 according to an embodiment of the present invention.

Referring to FIG. 1, the electronic device 100 includes for example, a communication unit 110, a control unit 120, and a notification unit 130. The control unit 120 includes, for example, a short timer (e.g. timer S) 121 and a on timer (e.g. timer L) 123. The notification unit 130 includes, for example, a display 131, a speaker 133, and a vibration unit 135.

According to an embodiment of the present invention, the communication unit 110 receives a message or event from an external server or terminal. The communication unit 110 may generally support a 3^{rd} Generation/4^{th} Generation (3G/4G) communication network or a wireless network such as Wireless Fidelity (WiFi). In addition, the communication unit 110 may also support a wireless communication such as Bluetooth, Near Field Communication (NFC), or a standard of the Infrared Data Association (IrDA) as well as a wired communication such as a Local Area Network (LAN). According to an embodiment of the present invention, the communication unit 110 provides the control unit 120 with a message or event received via various communication networks.

In an embodiment of the present invention, the communication unit 110 may be replaced with an event sensing unit. According to an embodiment of the present invention, the event sensing unit receives a signal for an event that occurs in the electronic device 100, in addition to a message received external to the electronic device 100 via a communication network. For example, the event sensing unit receives a chat message external to the electronic device 100 and internally receives a signal for an event sensed by a sensor.

According to an embodiment of the present invention, the control unit 120 is responsible for the operation control of the electronic device 100 and controls the short timer 121 and the long timer 123 to determine whether to allow message notification. According to an embodiment of the present invention, the control unit 120 changes the cycle of the short timer 121 or the long timer 123 based on a user input or a terminal configuration, and determines a message notification method.

According to an embodiment of the present invention, the short timer 121 operates to limit notification. For example, when the short timer 121 has a cycle of ten seconds, notification of a message received within ten seconds after the short timer 121 is initialized is not provide to a user. The short timer 121 may also be referred to as “timer S” (e.g. short timer) or “first timer” to distinguish it from the long timer 123. In an embodiment of the present invention, when the long timer 123 is referred to as a first timer, the short timer 121 may be referred to as a “second timer.”

According to an embodiment of the present invention, the long timer 123 operates to provide a notification. Since notification of a message received before the short timer 121 expires is not provided to a user, the electronic device 100 provides notification of received, unchecked messages (e.g. events) at an appropriate time. According to an embodiment of the present invention, the short timer 121 is initialized whenever a message arrives (e.g. whenever an event occurs), and thus the expiration time of the short timer 121 continues to be extended, as is described below. For example, when the short timer 121 is initialized before a first cycle of the short timer 121 expires, its second cycle resumes from the initialized time. In such a manner, the expiration time of the short timer 121 continues to be extended and thus may not expire for a greater time than the long timer 123. In an embodiment of the present invention, when the long timer 123 expires before the short timer 121 expires, the control unit 120 provides notification of messages received while the long timer 123 operates. In an embodiments of the present invention, the notification may also be notification of all or at least some of the messages received (e, g, events that have occurred) while the long timer 123 is operated. The long timer 123 may also be referred to as “timer L” (e.g. long timer) or “second timer” to distinguish it from the short timer 121. In an embodiment of the present invention, when the short timer 121 is represented by a second timer, the long timer 123 is represented by a first timer.

In an embodiment of the present invention, the first timer refers to a long timer and the second timer refers to a short timer. In this case, the first timer operates to provide notification. Also, the second timer operates to limit notification. For example, notification of an event sensed during the cycle of the second timer is not provided, and when the first timer expires, notification that has not been provided is provided to a user.

According to an embodiment of the present invention, the notification unit 130 provides notification of a message or event that is received from the electronic device 100 or occurs thereon. The notification unit 130 includes, for example, the display 131, the speaker 133, and the vibration unit 135. In an embodiment of the present invention, the speaker 133 is an output device and the vibration unit 135 is a vibrator or a motor. The notification unit 130 includes various notification units in addition to the examples enumerated. For example, notification may also be provided in such a manner that a Light Emitting Diode (LED) attached to the electronic device 100 flickers.

The display 131 provides notification by displaying the title of a message or an event, or all or some of the contents, for example. When an application is being executed, for example, when a chat application is being executed (e.g. displayed) and a new message is received, a separate message reception notification may be omitted. According to an embodiment of the present invention, when an application is being executed in the background (e.g. not displayed) or the electronic device 100 is in a locked state, a text representing a message or an icon may be displayed on a portion of a screen.

According to an embodiment of the present invention, the speaker 133 provides a notification via sound that a message has arrived. Sound may be provided alone or along with a display as described above. According to an embodiment of the present invention, the type of sound to be produced when providing a notification may be changed by a user's setting.

According to an embodiment of the present invention, the vibration unit 135 provides a notification via a vibration that a message has arrived. When the electronic device 100 is in a manner mode (e.g., a vibration mode or silent mode, in which the electronic device 100 provide an alarm without using sound), vibration notification via the vibration unit 135 instead of sound notification via the speaker 133 is provided. However, the present invention is not limited thereto and notification may be provided in various forms via a combination or modification.

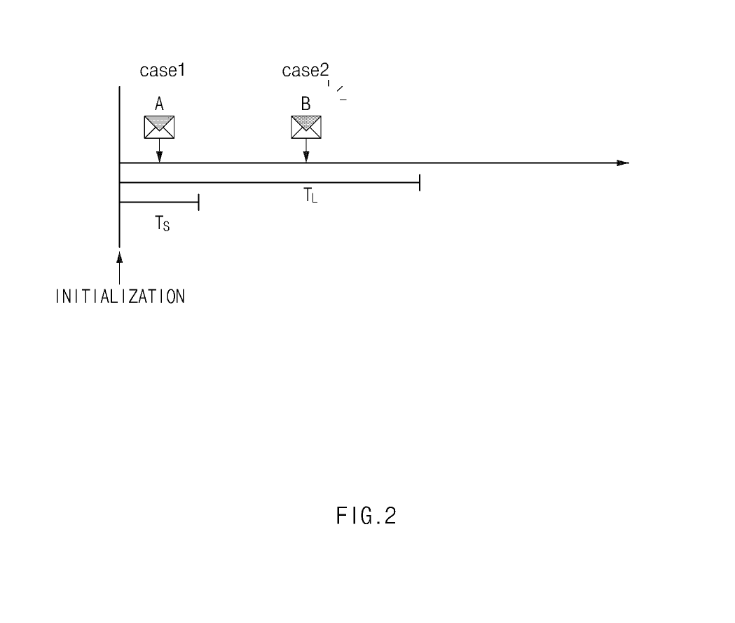

FIGS. 2 to 7 are illustrations of message notifications according to embodiments of the present invention.

FIG. 2 is an illustration of a message notification based on a time when a message is received from when a timer is initialized according to embodiments of the present invention.

According to an embodiment of the present invention, the initialization of the timer refers to when the tinier, having a certain cycle, begins a countdown. For example, when the long tinier, having a cycle of 300 seconds, is initialized, the long timer begins counting down from 300 in a sequence of 299, 298, etc. The electronic device 100 provides notification of a message at the time when the long timer expires (i.e., when it counts down to 0).

Referring to FIG. 2, a short timer having a cycle T_{S} and a long timer having a cycle T_{L} are initialized simultaneously. In an embodiment of the present invention, either the short timer is initialized alone or the short timer and the long timer are initialized simultaneously. When the short timer is initialized alone, the long timer continues to operate until the long timer expires, irrespective of the initialization of the short timer. Also, the expiration of the long timer causes an initialization of the long timer. In other words, the long timer is initialized simultaneously with its expiration.

According to an embodiment of the present invention, when a message is received before the short timer expires (e.g. a message is received at time A), the electronic device 100 does not provide a notification of the message. When the message is received after the short timer expires (e.g. the message is received at time B), the electronic device 100 provides a notification of the message. In this example, the messages received at times A and B are received before the long timer expires. In case 1, when the long timer expires, a notification of the message received at time A is provided. In case 2, when a notification of the message received at time B is provided, both the short timer and the long timer are initialized, based on when the notification is provided.

According to an embodiment of the present invention, when a message is received before the short timer expires and time T, lapses after being initialized, a notification of a received message is provided. When both the short timer and the long timer expire without the reception of a message, the electronic device 100 does not provide a notification of a message. In an embodiment of the present invention, when both the short timer and the long timer expire without the reception of a message, the electronic device 100 provides a notification that no message has been received. For example, the electronic device 100 provides information such as “No message has been received for the last 30 minutes” via display or sound. In this example, “30 minutes” refers to the cycle T_{L} of the long timer.

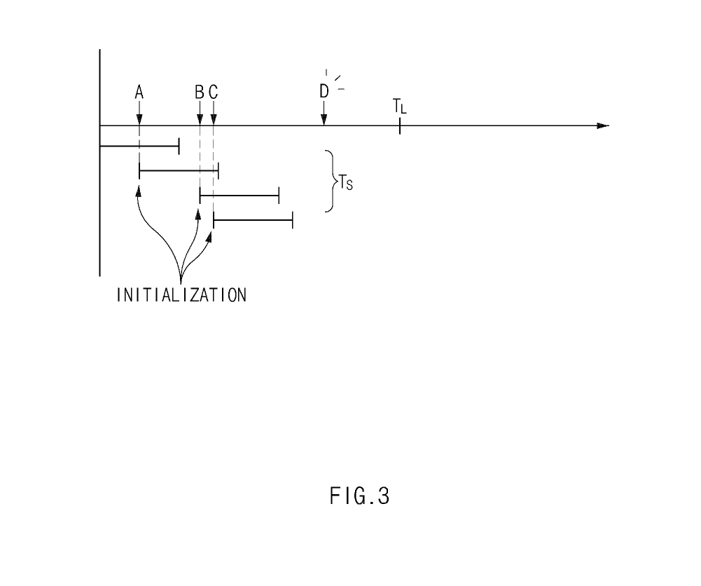

FIG. 3 is an illustration of a message notification according to an initialization of a short timer according to embodiments of the present invention.

Referring to FIG. 3, according to an embodiment, a first message A is received after the short timer and a long timer are initialized. As described with reference to FIG. 2, a notification of message A, which is received before the expiration of the short timer, is not provided.

According to an embodiment, when the message A is received, the short timer is initialized. In this case, the long timer continues to count without being initialized.

According to an embodiment, a second message B is received. The second message B is received after the expiration of the short timer, viewing from when both the short timer and the long timer are initialized, but before the expiration of the short timer viewing from when the short timer is initialized a second time. In this case, the electronic device 100 determines that the short timer does not expire, initializes the short timer a third time, and does not provide a notification of the second message.

According to an embodiment of the present invention, a third message C is received C. The third message is received before the expiration of the short timer viewing from when the short timer is initialized for a third time. According to an embodiment of the present invention, the electronic device 100 does not provide a notification of the third message C and initializes the short timer a fourth time. That is, the short timer continues to be initialized due to the message received before the expiration of the short timer, and thus the expiration of the short timer is extended.

According to an embodiment of the present invention, when the short timer is initialized by the third message C and a fourth message D is received after the expiration of the short timer lastly initialized D, the electronic device 100 provides a notification of at least one message received after the initialization of the long timer. In this case, the electronic device 100 may generate a sound or a vibration. For example, a sound (e.g. an audio message) such as “A total of four messages have been received” may be produced. According to an embodiment of the present invention, the received, accumulated messages may be aligned in at least one of a list form or a form including a list and some of the content and provided on the display 131 of the electronic device 100. In an embodiment of the present invention, the electronic device 100 provides a notification of the only the last message received. Various embodiments of the notification provided are described below.

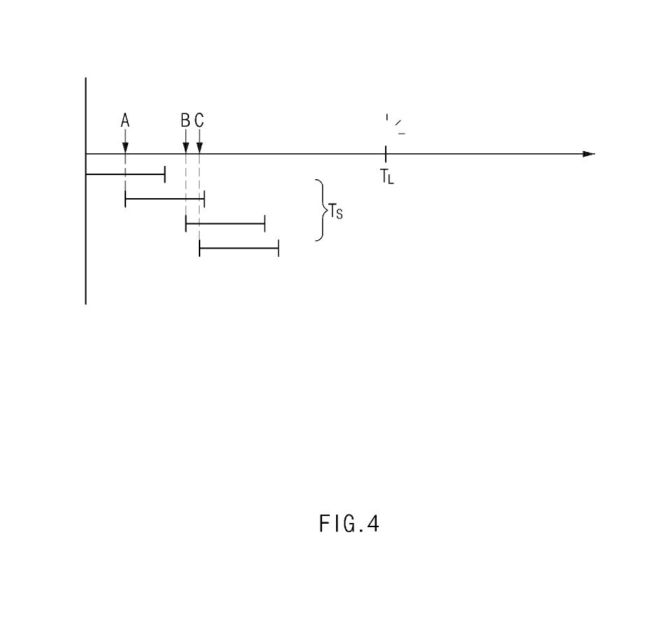

FIG. 4 is an illustration of a message notification according to an expiration of a long timer according to embodiments of the present invention.

in the embodiments of the present invention shown in FIG. 4, according to an embodiment of the present invention, the reception situation of three messages after the short timer and the long timer are initialized simultaneously may be understood as the reception situation of the first to third messages as illustrated in FIG. 3 and described above. In this case, notifications of the three messages are not provided for a user.

According to an embodiment of the present invention, when the long timer expires (e.g. such as when time T_{L} lapses after being initialized) without the reception of another message, the electronic device 100 provides a notification of a message received before the expiration of the long timer. For example, the electronic device 100 provides a notification of a total of three received messages at the expiration of the long timer T_{L} in the example shown. According to an embodiment of the present invention, when a user checks one of the received messages by using any method (e.g. such as when the user checks the message via other electronic devices connected to (e.g. synchronized with or coupled to) the electronic device 100) or checks an event displayed on a screen, because an event is set so that a notification of the event is provided irrespective of a timer), the electronic device 100 provides a notification of the message (e.g. such as two messages) not checked by the user. In an embodiment of the present invention, the electronic device 100 provides notifications of all of the messages received within the cycle T_{L} of the long timer, irrespective of whether a message has been received.

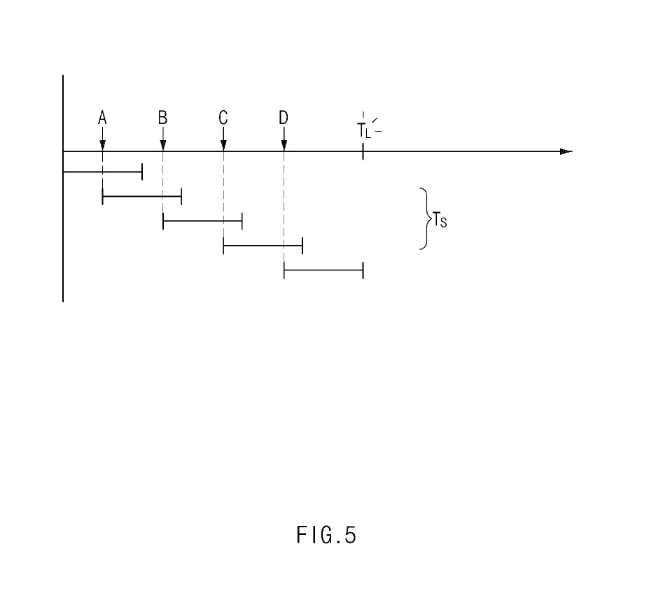

FIG. 5 is an illustration of a message notification according to an expiration of a long timer before an expiration of a short timer according to embodiments of the present invention.

Referring to FIG. 5, after the short timer and the long timer are initialized, the short timer may be extended by messages sequentially received. According to an embodiment of the present invention, when a message continues to be received at an interval shorter than the cycle T_{S} of the short timer, the short timer continues to be initialized and its expiration continues to be extended. In this case, the extended expiration of the short timer may be later then the expiration of the long timer. FIG. 5 illustrates when the expiration of the short timer is later than the expiration of the long timer by receiving messages four times, but in various embodiments of the present invention, there may be various cases. For example, when the cycle T_{S} of the short timer is ten seconds and the cycle T_{L} of the long timer is thirty minutes (i.e., 1800 seconds), receiving messages 180 times or more will make the expiration of the short timer later than that of the long timer.

According to an embodiment of the present invention, when the long timer expires, a message notification is provided even before the short timer expires. For example, the long timer has priority over the short timer. When the long timer expires, notifications of messages (e.g. four messages in FIG. 5) received during the operation of the long timer are provided. In this case, when the notification of the message is provided, the short timer that has not expired is initialized. In other words, the expiration of the long timer, the notification of an event, the initialization of the long timer, and the initialization of the short timer occurs substantially simultaneously. Thus, if a new message is received at a time within the cycle T_{S} of the short timer initialized by a message received at time D, but after T_{L}, a notification of the new message is not provided.

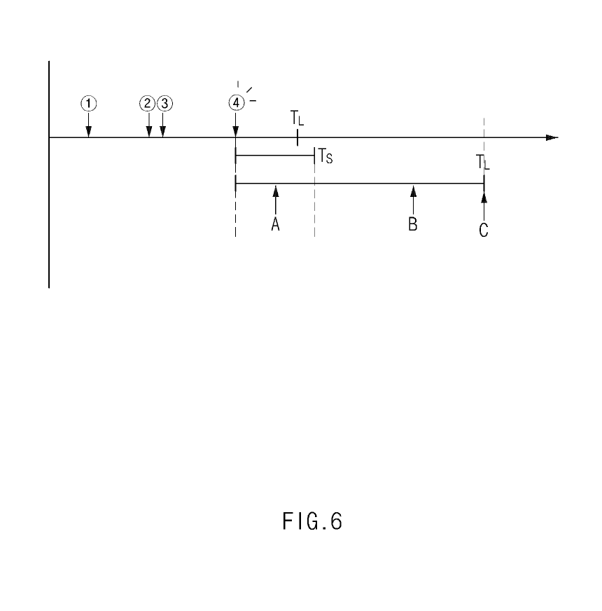

FIG. 6 is an illustration of where a timer is initialized in response to a notification of a message according to embodiments of the present invention.

FIG. 6 may be understood as a variation of the situation shown in FIG. 3 and described above. In response to the reception of the third message, a short timer is initialized. According to an embodiment of the present invention, when a fourth message is received after the expiration of the short timer thirdly initialized after the short timer was initially initialized, the electronic device 100 provides a notification of messages previously received in response to the reception of the fourth message. The provided notification may correspond to a single notification related to the 4 messages including previously received messages and the fourth messages According to an embodiment of the present invention, the electronic device 100 initializes the short timer and the long timer in response to the message notification. According to an embodiment of the present invention, the long timer is not initialized by an event in which a message is received, but is initialized by an event in which a notification of a message is provided. In the example shown in FIG. 6, the long timer is initialized before its cycle T_{L} expires.

In the example shown in FIG. 6, a notification of a message is provided in response to the reception of the fourth message and both the short timer and the long timer are initialized. According to an embodiment of the present invention, if the cycle T_{L} of the long timer expires based on the initial initialization time, a message notification is not provided. Since a message notification is provided when the fourth message is received, there may be no remaining message to be provided.

According to an embodiment of the present invention, when a message is received before the expiration of the short timer, which is newly initialized (e.g. initialized in response to the fourth message), (such as when the message is received in time section A), a message notification is not provided. In this case, a notification of a received message is provided at the expiration (e.g. time point C) of the long timer, which is newly initialized. According to an embodiment of the present invention, a notification of a message received after the expiration of the short timer, which is newly initialized, (e.g. a message received in time section B) may be provided immediately upon receiving the message.

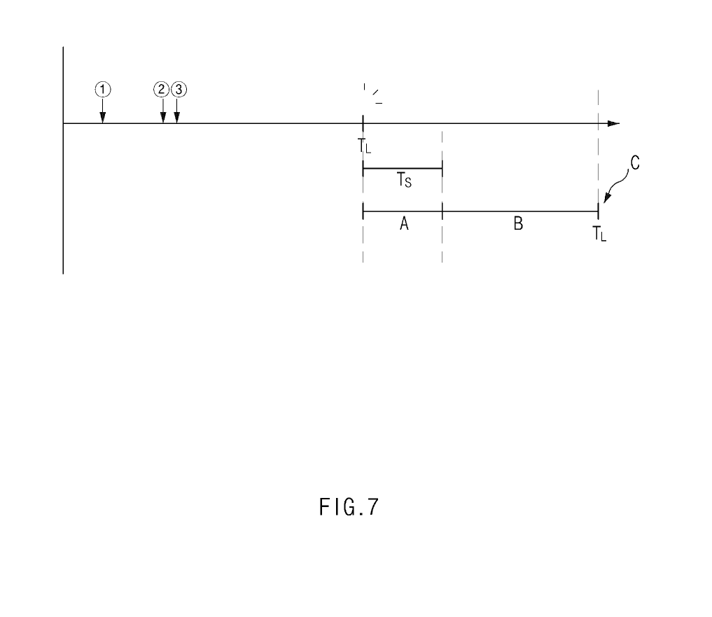

FIG. 7 is an illustration of an example where a timer is initialized in response to an expiration of a long timer according to embodiments of the present invention.

FIG. 7 may be understood as a variation of the situation shown in FIG. 4 and described above. According to an embodiment of the present invention, the long timer may expire without the reception of another message after the reception of a third message. Notifications of messages (e.g., three messages) received at the expiration of the long timer are provided. When the notification is provided, both the long timer and a short timer are initialized. According to an embodiment of the present invention, a notification of a message received before the expiration Tₛ of the short timer (e.g. a message received at time section A) is not provided, in this case, a notification of a received message is provided at the expiration (e.g. time section C) of the long timer, which was initialized. According to an embodiment of the present invention, a notification of a message received after the expiration Tₛ of the short timer a message received at time section B) is provided immediately upon receiving the message.

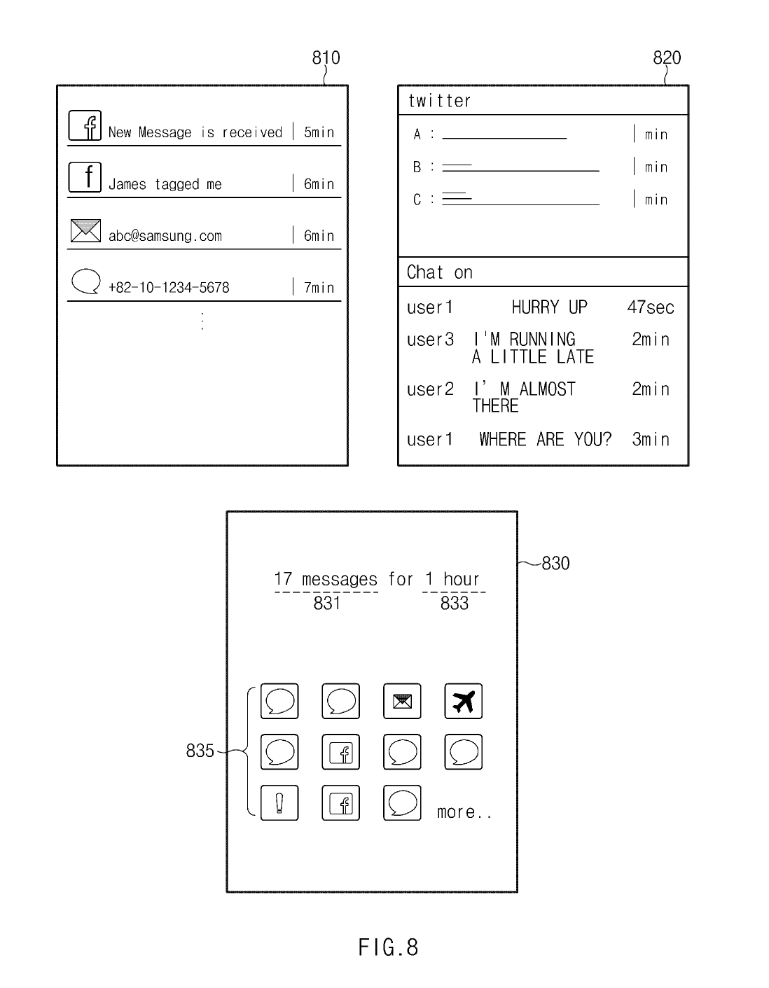

FIG. 8 is an illustration of a message notification method according to various embodiments of the present invention. According to an embodiment of the present invention, FIG. 8 may be understood as representing examples where a message notification is displayed on the display 131 of the electronic device 100.

According to an embodiment of the present invention, a notification of Facebook Messenger, Facebook, E-mail or SMS message may be provided as shown on screen 810. As described above, a message may include some information provided to a user, for example, at least one of information of a message received via Facebook Messenger, information that another user (e.g., James) on Facebook has tagged a user of the electronic device 100, information of an E-mail received from abc@samsung.com, or information of a text message received from +82-10-1234-5678, in embodiments of the present invention disclosed herein.

According to an embodiment of the present invention, the cycle of the long timer is 30 minutes and the cycle of the short timer is greater than or equal to 30 seconds, in an example shown on screen 810. In embodiments of the present invention, since displaying a message without any sound or vibration may not cause a user stress or disturb the user, depending on the situation, a received message may be displayed before the long timer expires. According to an embodiment of the present invention, notifications displayed on the screen 810 of the electronic device 100 may be a notification message due to the expiration of the long timer. The notification messages may be displayed in the form of a list in which messages received during the operation of the long timer are represented in a received sequence. In the example shown in FIG. 8, messages previously received are arranged on the lower part and messages recently received may be arranged on the relatively upper part. These arrangements are mere examples and, on the contrary, recent messages may be arranged on the lower part of the screen 810.

According to an embodiment of the present invention, received messages may be displayed in the form of a list according to related applications as shown on screen 820. For example, among messages received during the operation of the long timer, a group of messages corresponding to a Twitter application and a group of messages corresponding to a ChatOn application may be separately displayed. According to an embodiment of the present invention, an application group occupying the upper part among the groups of messages may be an application group corresponding to the latest received message, an application corresponding to the earliest received message, an application having the highest usage frequency or an application determined according to other predefined criteria.

According to an embodiment of the present invention, when a notification is provided by the grouping of messages according to an application, a notification of an interactive application such as Facebook Messenger, ChatOn, KakaoTalk or Line may be efficiently provided. According to an embodiment of the present invention, some message notifications may be limited by the short timer, and there may be many message notifications that are provided at a later time. According to an embodiment of the present invention, when messages corresponding to an interactive application are provided by grouping according to an application, a user may recognize the flow of dialog at a glance without unlocking a device or executing an application.

According to an embodiment of the present invention, received messages may be arranged in the form of an icon on screen 830. For example, the arrangement may have various forms such as a 3×3 array or a 4×3 array. In the example shown in FIG. 8, the number of received messages 831 may be displayed along with the cycle of the long timer 833 in addition to icons 835. According to an embodiment of the present invention, a screen 830 may provide information that 17 messages (e.g. the number of messages 831) have been received within one hour (e.g. the cycle of the long timer 833). In embodiments of the present invention, the cycle of the long timer 833 may be replaced with the time between when initialization is performed and when a notification is provided. For example, when the short timer is set to five minutes and the long timer is set to one hour, and three messages are received within an interval of four minutes from the initialization time of the timers and once within an interval of ten minutes (e.g. four messages are received for a total of 22 minutes), the electronic device 100 provides a notification of when the last message is received and, in this case, “4 messages (831) for 22 min (833)” is be displayed on screen 830.

In embodiments of the present invention, an application related to a received message may be displayed in the form of an icon. According to an embodiment of the present invention, icons 835 may be arranged so that the recently received message is placed at the upper left-corner. When the number of received messages exceeds the number of messages that can be displayed on one screen, for example when a display provides a 4×3 array but the number of received messages 831 is 17, the electronic device 100 may provide, for example, an icon such as “more” that provides remaining messages, or displays remaining icons according to a scroll/drag input provided by a user.

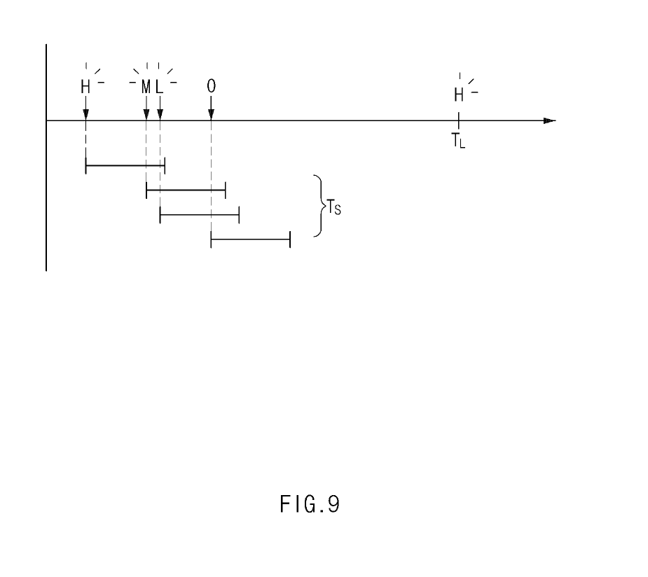

FIG. 9 represents a message notification method according to embodiments of the present invention. According to an embodiment of the present invention, FIG. 9 represents various examples where a message notification is provided via the speaker 133 or the vibration unit 135 of the electronic device 100.

According to an embodiment of the present invention in FIG. 9, a short timer having a cycle T_{S} and a long timer having a cycle T_{L} are initialized. According to an embodiment of the present invention, the electronic device 100 provides a notification within a pre-defined number of time (e.g. a grace period/time) after the first initialization, and then provides a notification by determining whether the short timer expires as described above.

In FIG. 9, it is assumed for the convenience of description that first, second, third, and fourth messages are received before the expiration of the short timer. When the first message is received after the short timer is initialized, the electronic device 100 provides a notification of the first message through a sound or a vibration. According to an embodiment of the present invention, the intensity of the notification through the sound/vibration may be defined as at least one of the volume of the sound, the magnitude of the vibration, or the duration of the sound/vibration. The intensity of the notification may be defined incrementally (e.g., strong/medium/weak or high/middle/low) or sequentially (e.g., an arbitrary intensity between 1 and 10). The intensity of the notification may be defined by a device as described above as well as may be changed by a user setting. For example, the electronic device 100 may provide a setting menu and the intensity of the notification may be defined based on a user input through the setting menu. For example, a user may set the intensity of a vibration or a sound of a first message to ten, the intensity of a second message to five, the intensity of a third message to one and the intensity of a fourth message to zero. Furthermore, the user may also change the setting of the number of grace times. In the example described above, the number of times of grace is set to a total of three times (e.g. a notification of the fourth message is not provided), and the user may increase or decrease the number of grace times.

For example, when the intensity of the vibration/sound for the first message is set to High (H), the intensity of the vibration/sound for the second message is set to Medium (M), the intensity of the vibration/sound for the third message is set to Low (L), and a notification of the fourth message through vibration/sound may not be provided (e.g. intensity is zero).

According to an embodiment of the present invention, the long timer expires when time T_{L} lapses, as illustrated in FIG. 1 and described above. According to an embodiment of the present invention, the long timer is initialized based on when the last notification is provided (e.g. such as when a notification of a third message through vibration/sound is provided), as illustrated in FIG. 6 and described above. The short timer is initialized in response to the reception of a message, irrespective of whether the vibration/sound is provided.

In another example, when the vibration/sound of the electronic device 100 is set to 10, the intensity of a first message may be set to 70% of 10, the intensity of a second message may be set to 30% of 10, and the intensity of a third message may be set to 0% of 10 (e.g. a notification is not provided). Unlike previous examples, a notification is not provided for the third message in the present example. In embodiments of the present invention, the intensity, decrease rate or step of the vibration/sound of the electronic device 100 may be set to various values.

In embodiments of the present invention, the electronic device 100 may use one timer to provide a notification. For example, the electronic device 100 may initialize the timer and sense at least one event that occurs after the initialization. The electronic device 100 may provide notifications of a limited number of events received for a certain period of time after the initialization. Also, when events exceeding the limited number occur for a designated time, notifications of the exceeding events may not be provided. For example, when text messages are received ten times within the first ten seconds after initialization, the electronic device may provide reception notifications of the first three text messages, and may not provide notifications after the third text message. When a timer subsequently expires, the electronic device 100 may provide notifications of the fourth to tenth text messages for which no notifications have been provided. In embodiments of the present invention, the cycle of the timer may be set to be greater than or equal to a certain time (e.g. ten seconds).

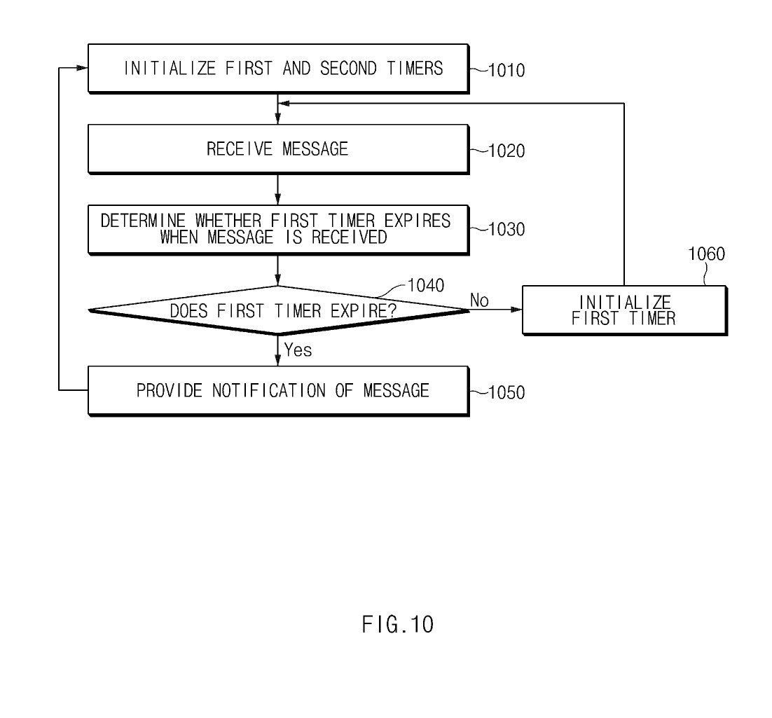

FIG. 10 is a flowchart of a message notification method according to an embodiment of the present invention,

Referring to FIG. 10, in step 1010, a first timer and a second timer are initialized. In this example, the first timer refers to the above-described short timer and the second timer refers to the above-described long timer.

According to an embodiment of the present invention, initialization occurs in various situations. When the electrical power of the electronic device 100 is on or when a message notification is provided as mentioned in the embodiments of the present invention described above, the first timer and the second timer are initialized simultaneously.

According to an embodiment of the present invention, the first timer and the second timer are initialized when it is determined that a user does not use a terminal. For example, when the above-described message notification is provided and a user touches the screen of the electronic device 100 in order to check the message notification, or a user input such as unlocking or an application, or app, execution is provided, the electronic device 100 determines that the user is using the electronic device 100, and thus may not operate timers. When a user no longer uses the electronic device 100, such as when the user turns off the screen, the screen is turned off due to the lapse of a certain time or the electronic device 100 enters a locked state, the electronic device 100 determines that the user does not use a terminal, and thus initializes the first timer and the second timer. As an example, when the first timer and the second timer are initialized by a message notification and the user immediately checks the message notification, the timers are inactivated, after which, when the user completes the check and turns off the display of the electronic device, the first timer and the second timer may be re-initialized or re-activated.

According to an embodiment of the present invention, the first timer and the second timer are initialized when the condition of the electronic device 100 is changed. For example, when the user manipulates the switch of the electronic device 100, changes the setting of the electronic device 100 to a manner (e.g. vibration) mode on a toggle/setting screen, the electronic device 100 determines that the user wants to decrease a message notification, and thus activates or initializes the first timer and the second timer. As another example, when the electronic device 100 enters an etiquette mode, the first timer and the second timer may be activated or initialized. In this example, the etiquette mode refers to a mode in which a notification such as a ringtone or a wakeup call is provided (e.g. rings) and a user turns the electronic device 100 upside down (such as the front of the electronic device 100 faces downward), a sensor senses this situation and a notification is not provided. In this case, the electronic device also determines that a user does not want to receive a message notification, and thus activates or initializes the first timer and the second timer.

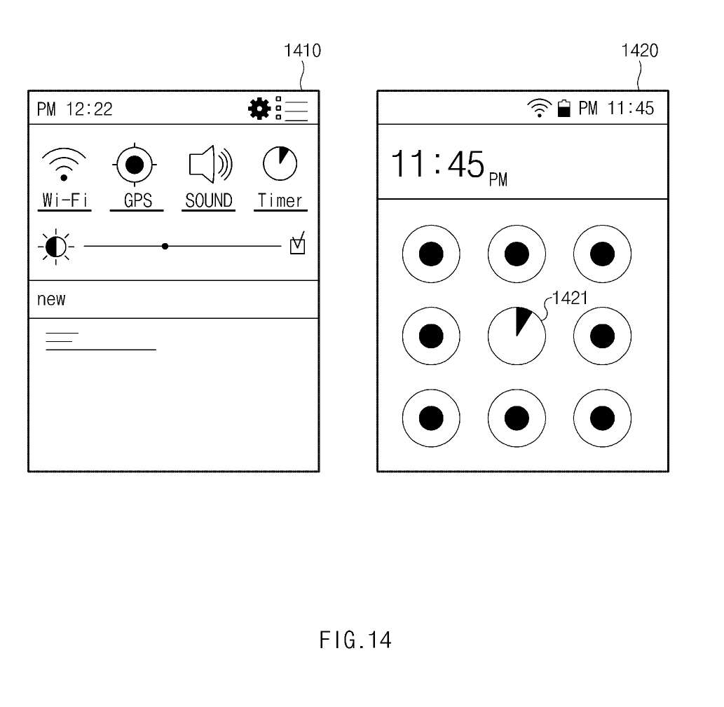

As another example, the electronic device 100 inactivates/activates the first timer and the second timer in response to a user input on a setting User Interface (UI), and when a timer is changed from an inactivated state to an activated state, each timer may be initialized. The activation of a timer is described below with reference to FIG. 14.

Referring to FIG. 10, a message is received in step 1020. The message may be understood as a concept including a signal for an event that occurs in the electronic device 100, in addition to a message received externally. According to an embodiment of the present invention, the electronic device 100 supports various applications and as applications installed by a user increase, numerous notifications may be provided. As an example, a game application may be provided in such a manner that the number of play times increases at an interval of a certain time (e.g. once every 5 minutes) or an instructed work is completed within several minutes (e.g., growth of crops takes two and a half minutes). It is possible to set notifications of these items in a game application and events corresponding to the examples above may be provided as notifications. According to an embodiment of the present invention, events are not received from an external server via the communication unit 110 but occur in the electronic device 100. According to an embodiment of the present invention, the communication unit 110 or an event sensing unit provides the control unit 120 with events that occur internally/externally to the electronic device 100 and are received,

According to an embodiment of the present invention, it is determined whether the first timer expires when the message is received, in step 1030. Step 1030 is performed by the control unit 120 of the electronic device 100, in step 1040, when it is determined that the first timer expires (e.g. the message is received after the expiration of the first timer), the method proceeds to step 1050. In step 1050, it is possible to provide a notification of at least one message that is received after the second timer is initialized. The message notification is provided via the notification unit 130.

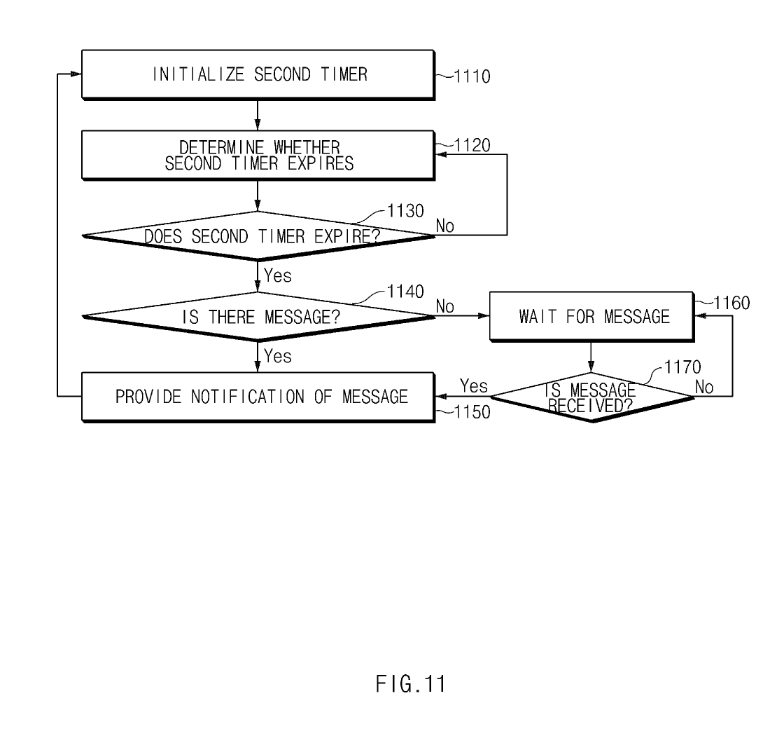

According to an embodiment of the present invention, when it is determined that the first timer does not expire (e.g. the message is received before the expiration of the first timer) in step 1040, the method proceeds to step 1060. In step 1060, the electronic device 100 initializes the first timer and enters a state of waiting for a reception of a message. In this case, the second timer is not initialized. Steps 1020 to 1040 and 1060 continue to be repeated and the expiration time of the first timer continues to be extended. According to an embodiment of the present invention, since the second timer is not initialized by a reception of a message, the second timer may expire earlier than the first timer, as described below with reference to FIG. 11.

FIG. 11 is a flowchart of a message notification method based on the expiration of a second timer according to an embodiment of the present invention.

Referring to FIG. 11, in step 1110, the second timer is initialized. When the second timer is initialized, the first timer may also be initialized. That is, step 1110 may correspond to step 1010 of FIG. 10.

According to an embodiment of the present invention, the electronic device 100 determines whether the second timer expires, in step 1120. Steps 1020 to 1040 and 1060 of FIG. 10 may continue to be performed between steps 1110 and 1120.

According to an embodiment of the present invention, when the second timer expires in step 1130, the method proceeds to step 1140. In step 1140, it is be determined whether there are messages received between the initializations of the second timer (e.g. between step 1110 and the expiration time of the second timer). When messages are received, the method proceeds to step 1150. In step 1150, the electronic device 100 provides a notification of at least one message that is received after the second timer is initialized. When the notification of a message is provided, the second timer is re-initialized (e.g. in step 1110).

According to an embodiment of the present invention, when there is no message received, the electronic device 100 enters a standby state. That is, the electronic device 100 waits until a message is received, in step 1160. When a message is received in step 1170, the electronic device 100 proceeds to step 1150 to provide a notification of the message and initializes the second timer (e.g. in step 1110). When the messaged is not received, the electronic device 100 continues in the standby state (e.g. in step 1160).

In FIG. 11, when there is no message in step 1140, it is possible to proceed to step 1110 to initialize the second timer. However, maintaining the second timer in an activated state even though the message is not received for a long time may be inefficient from a power management aspect. According to an embodiment of the present invention, when there is no notification at the expiration time of the second timer, the electronic device 100 temporarily deactivates the timer and re-activates the timer when a new message is received. According to an embodiment of the present invention, when there is no limitation in power management, such as when a terminal is being charged or when a percentage of remaining battery power is sufficiently high, it is possible to continue to maintain the second timer in an activated state.

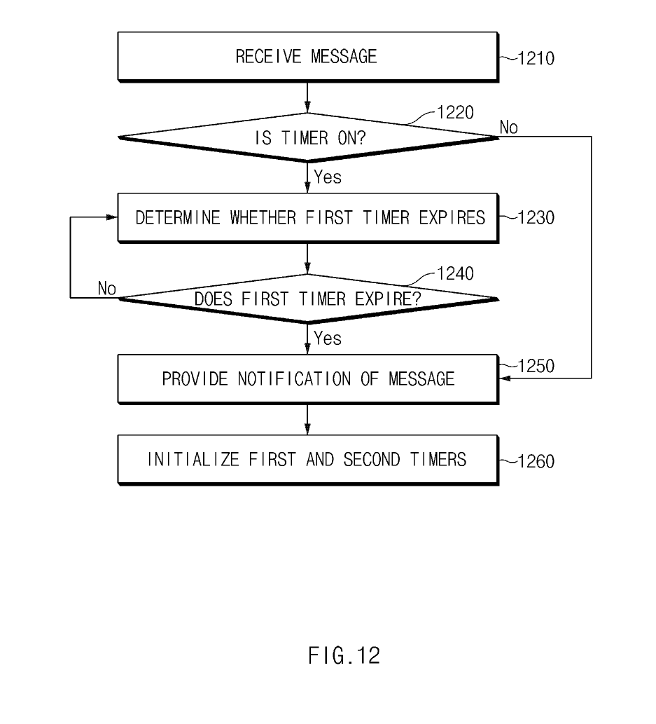

FIG. 12 is a flowchart of a message notification method based on an activation of a timer according to an embodiment of the present invention.

According to an embodiment of the present invention, the timer of the electronic device 100 may be in an inactivated state in many cases. When a user is using the electronic device 100, the timer may be inactivated because the user checks a message notification. According to an embodiment of the present invention, the electronic device 100 may also set the timer to OFF.

According to an embodiment of the present invention, the timer may also operate on all notifications that have occurred in the electronic device 100 but may also operate only on certain applications. For example, the timer may not operate on a relatively intermittently received text message (e.g. SMS) or mail message but may operate on a chat application that supports a group chat function. An application to which the timer is applied may be set by a user. According to an embodiment of the present invention, timers may respectively operate on a first application and a second application or the same timer may operate on a plurality of applications. For example, a short timer and a long timer that have certain cycles may operate on a ChatOn application, and another short timer and another long timer that have cycles different from the certain cycles may operate on another chat application. In another embodiment of the present invention, without classifying messages related to different applications for which timers are set, the electronic device 100 may apply a short timer and a long timer having certain cycles to provide notifications.

Referring to FIG. 12, a message is received in step 1210. In step 1220, the electronic device 100 determines whether a timer is in an activated state. In an embodiment of the present invention, the electronic device 100 determines whether a timer operating on all messages of the electronic device 100 is in an activated state. In an embodiment of the present invention, the electronic device 100 determines whether a timer operating on an application of the electronic device 100 is in an activated state.

According to an embodiment of the present invention, when the timer is in the activated state, the method proceeds to step 1230. In step 1230, it is determined whether a first timer expires and when the determination is positive, it is possible to move from step 1240 to step 1250. In step 1250, a notification of a received message may be provided. According to an embodiment of the present invention, when a notification of a message is provided, the electronic device 100 initializes both the first timer and the second timer in step 1260. When the first timer does not expire in step 1240, it is possible to proceed to step 1230. In step 1230, the electronic device 100 may initialize the first timer and receive a next message.

According to an embodiment of the present invention, when the timer is in a deactivated state in step 1220, the electronic device 100 directly proceeds to step 1250 to provide a notification of a message. In an embodiment of the present invention, when a notification of a message is provided, the timer is automatically activated and the first timer and the second timer are initialized.

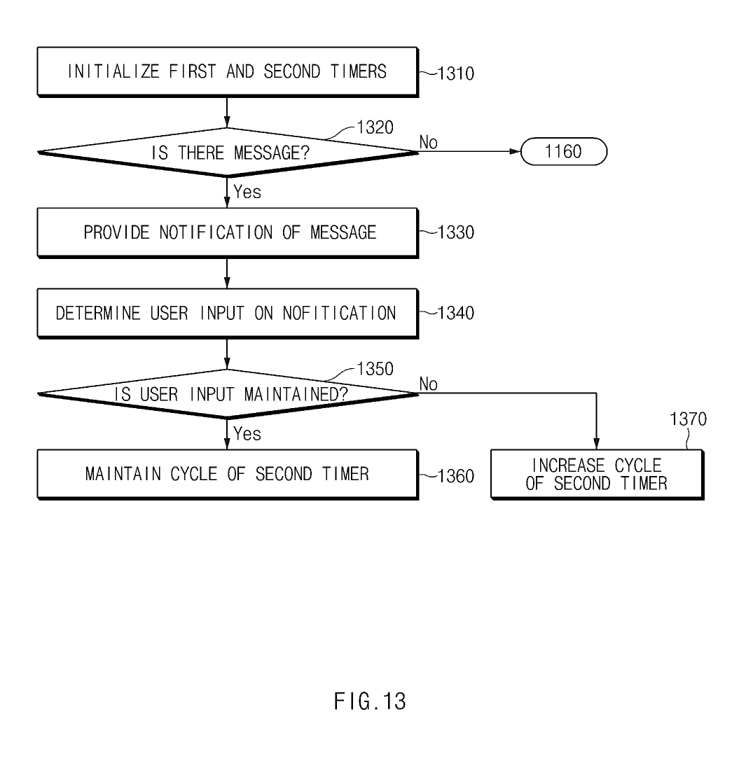

FIG. 13 is a flowchart of a cycle change method of a second timer according to an embodiment of the present invention.

According to an embodiment of the present invention, the cycle of a first timer and the cycle of the second timer may be dynamically set. For example, the electronic device 100 may set the cycle of the first timer to ten seconds and the cycle of the second timer to 15 minutes. However, each user may want to set the cycles of the timers differently. For example, a user who wants to very occasionally check a notification may set the cycle of the first timer to five minutes and the cycle of the second timer to one hour. In the embodiment of the present invention shown in FIG. 13, in addition to the direct cycle change by a user via a setting menu, a method of appropriately changing the cycle by the electronic device 100 is illustrated.

Referring to FIG. 13, in step 1310, the second timer may expire. Step 1310 may be understood to be similar to the method performed at the expiration of the second timer of FIG. 11. If there is a message received by the expiration of the second timer in step 1320, it is possible to proceed to step 1330 to provide a notification of the message. If there is no message, it is possible to proceed to a step corresponding to step 1160.

According to an embodiment of the present invention, in step 1340, it is possible to determine a user input on a provided notification. When a user checks a message immediately or within a certain time in response to a provided message notification in step 1350 (e.g. when the electronic device 100 senses a user input), the electronic device 100 maintains the cycle of the second timer in step 1360. According to an embodiment of the present invention, when there is no user input within a certain time in step 1350, the electronic device 100 proceeds to step 1370 to increase the cycle of the second timer. For example, when the cycle of the second timer is 30 minutes, the cycle of the second timer may be reset to 33 minutes (e.g. an increase of 10%), or 35 minutes (e.g, an increase of five minutes). According to an embodiment of the present invention, the cycle reset of the timer may be immediately performed but may also be performed based on accumulated data. For example, when the cycle (e.g. 30 minutes) of the second timer expires 20 times a day and an average time spent from when the second timer expires to when a user checks a message is 15 minutes, it may be determined that the user occasionally checks messages and the electronic device may reset the cycle of the second timer to 45 minutes (e.g. an increase of 15 minutes from 30 minutes). The timer cycle change is exemplary and the cycle of the timer may vary depending on at least one of a certain rate, a certain time length, average data, a certain rate of average data or an increase/decrease limitation.

FIG. 14 is an illustration of a tinier setting interface according to an embodiment of the present invention.

According to an embodiment of the present invention, a screen 1410 represents a toggle screen for setting a timer. For example, when the timer is activated, it may be displayed in such a manner that the color of the “Timer” item in a toggle switch is distinguished from an deactivated item. For example, whereas the deactivated item is displayed in gray color, the activated timer may be displayed in a fluorescent color. According to an embodiment of the present invention, when an input touching the Timer item in a toggle switch is received from a user, the electronic device 100 changes the setting of the timer from an activated state to an deactivated state or vice versa.

According to an embodiment of the present invention, a screen 1420 represents how to set the timer on a locked screen. For example, when many group chat messages are received within a short time while a user places the electronic device 100 on his or her desk and is out of the office for a long time, other people may be disturbed. Since other people cannot unlock the electronic device 100 and a vibration continues to be generated even if they change a notification method from sound to vibration, other people may be disturbed. According to an embodiment of the present invention, other people may also activate the timer of the electronic device 100 by providing a UI that may activate/deactivate the timer by using a certain method on a locked screen. When the timer is activated, notifications of many messages received are blocked by the short timer and not provided until the long timer expires, so that other people are not disturbed.

A method of providing a notification by an electronic device according to an embodiment of the present invention may include initializing a first timer and a second timer that operate to control the notification; sensing that at least one event occurs; comparing the occurrence time of the event with the state of the second timer to determine whether to restrict the notification; and providing a notification of at least one notification-restricted event by the second timer occurring after the initialization of the first timer, when the first timer expires.

In an embodiment of the present invention, the cycle of the first timer may be set to be longer than the cycle of the second timer.

In an embodiment of the present invention, the method may further include initializing the second timer when the at least one event occurs.

In an embodiment of the present invention, the method may further include initializing the first timer and the second timer when the notification is provided.

In an embodiment of the present invention, determining whether to restrict the notification may not provide a notification of the event if the second timer does not expire when the event occurs, and may provide the notification of the event if the second timer expires when the event occurs.

In an embodiment of the present invention, providing the notification of the event may include providing the notification of the event even before the second timer expires.

In an embodiment of the present invention, the electronic device may provide a notification even before the first timer expires, when an event corresponding to a designated condition occurs. Also, the designated condition may include at least one of the sender of the event, an application related to the event, and content included in the event.

In en embodiment of the present invention, providing the notification may include events occurring during the operation time of the first timer, in the form of icons on the screen.

In an embodiment of the present invention, determining whether to restrict the notification may include providing the notification, and changing the intensity of notifications of a designated number of events that occur after the initialization of the first timer. Also, the intensity of the notification may include at least one of the intensity of the vibration of the electronic device and the volume of sound related to the event.

In an embodiment of the present invention, the method may further include increasing the cycle of the first timer when a user input checking a provided notification is not received within a certain time, in response to the operation of providing the notification.

The method of providing a notification by an electronic device according to an embodiment of the present invention may include initializing a timer operating to control the notification; sensing the occurrence of at least one event; and restricting a notification of an exceeding event when the event exceeds a limited number for a designated time after the initialization.

In an embodiment of the present invention, the method may further include providing a notification of a notification-restricted event when the timer expires.

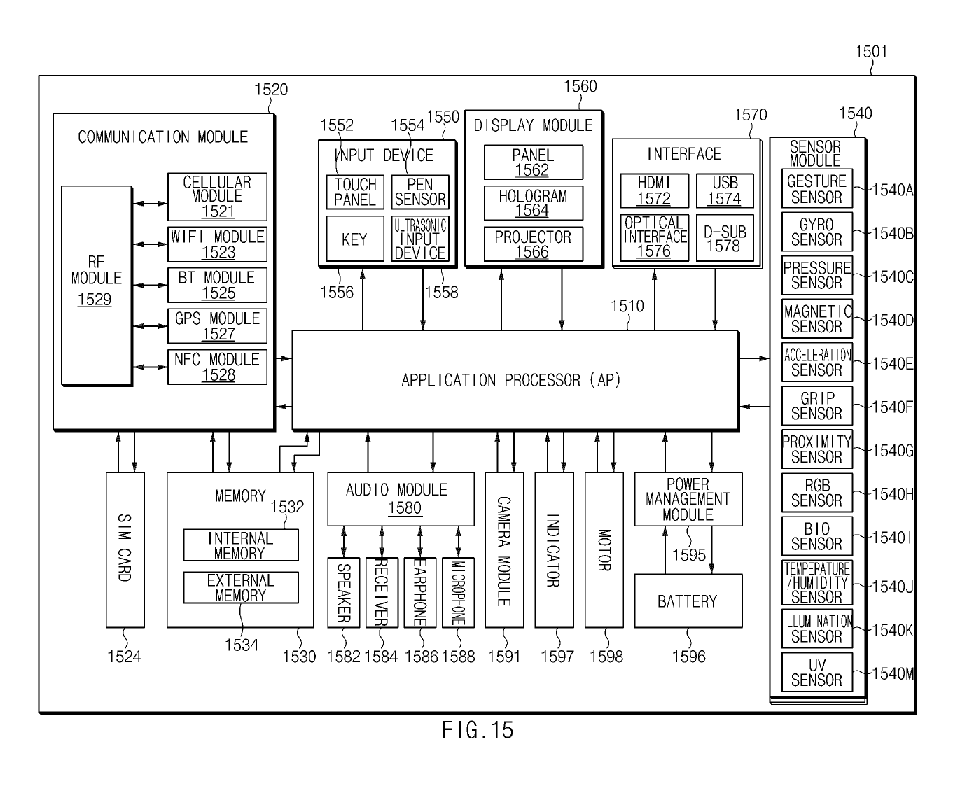

FIG. 15 is a block diagram of an electronic device 1501 according to an embodiment of the present invention The electronic device 1501 includes all or some of the electronic device 100 shown in FIG. 1, for example.

Referring to FIG. 15, the electronic device 1501 includes one or more Application Processor (APs) 1510, a communication module 1520, a Subscriber Identification Module (SIM) card 1524, a memory 1530, a sensor module 1540, an input device 1550, a display 1560, an interface 1570, an audio module 1580, a camera module 1591, a power management module 1595, a battery 1596, an indicator 1597, and a motor 1598.

The AP 1510 executes an operating system or application programs to control a plurality of hardware or software components connected to the AP 1510 and performs processing and calculation on various pieces of data including multimedia data. The AP 1510 may be implanted in a System on Chip (SoC) for example. According to an embodiment of the present invention, the AP 1510 may further include a Graphics Processing Unit (GPU).

The communication module 1520 (such as a communication unit 110) performs data transmission and reception when performing communication between the electronic device 1501 (such as an electronic device 100) and other electronic devices connected via a network. According to an embodiment of the present invention, the communication module 1520 includes a cellular module 1521, a WiFi module 1523, a Bluetooth (BT) module 1525, a GPS module 1527, an NFC module 1528, and a Radio Frequency (RF) module 1529.

The cellular module 1521 provides a voice call, a video call, a message service, or an Internet service via a communication network (such as an Long Term Evolution (LTE), LTE Advanced (LTE-A), Code Division Multiple Access (CDMA), Wideband CDMA (WCDMA), Universal Mobile Telephone System (UMTS), Wireless Broadband (WIBro) or Global System for Mobile communication (GSM) network). Also, the cellular module 1521 may use, for example, a Subscriber Identity Module (SIM) card 1524 to perform the identification and authentication of an electronic device in a communication network. According to an embodiment of the present invention, the cellular module 1521 performs at least some of the functions that the AP 1510 provides. For example, the cellular module 1521 may perform at least some of multimedia control functions.

According to an embodiment of the present invention, the cellular module 1521 may include a Communication Processor (CP). Also, the cellular module 1521 may be implemented in an SoC, for example. FIG. 15 shows components such as a cellular module 1521 (such as a communication processor), a memory 1530 and a power management module 1595 separately from the AP 1510, but according to an embodiment, the AP 1510 may be implemented to include at least some (such as a cellular module 1521) of the above-described components.

According to an embodiment of the present invention, the AP 1510 or the cellular module 1521 (such as a communication processor) may load, on volatile memories, commands or data received from at least one of a non-volatile memory connected thereto or another component, and may process the commands or data. Also, the AP 1510 or the cellular module 1521 may store, on non-volatile memories, data received from at least one of the other components or generated by at least one of the other components.

Each of the WiFi module 1523, the ST module 1525, the GPS module 1527 and the NFC module 1528 may include a processor for processing data transmitted and received via a corresponding module, for example. FIG. 15 shows each of the cellular module 1521, the WiFi module 1523, the ST module 1525, the GPS module 1527, and the NFC module 1528 as a separate block, but according to an embodiment of the present invention, at least some (e.g., two or more) of the cellular module 1521, the WiFi module 1523, the ST module 1525, the GPS module 1527, and the NFC module 1528 may be included in one integrated circuit or chip (IC) or an IC package For example, at least some (such as a communication processor corresponding to the cellular module 1521 and a WiFi processor corresponding to the WiFi module 1523) of the processors corresponding to the cellular module 1521, the WiFi module 1523, the ST module 1525, the GPS module 1527, and the NFC module 1528, respectively, may be implemented in one SoC.

The RF module 1529 performs data transmission and reception, such as transmission and reception of an RF signal. The RF module 1529 may include e.g., a transceiver, a Power Amplifier Module (PAM), a frequency filter or a Low Noise Amplifier (LNA). Also, the RF module 1529 may further include a part such as a conductor or wire for transmitting and receiving electromagnetic waves in free space when performing wireless communication. Although FIG. 15 shows that the cellular module 1521, the WiFi module 1523, the BT module 1525, the GPS module 1527, and the NFC module 1528 share one RF module 1529, at least one of the cellular module 1521, the WiFi module 1523, the BT module 1525, the GPS module 1527, and the NFC module 1528 may transmit and receive an RF signal via a separate RF module according to an embodiment of the present invention.

The SIM card 1524 and may be inserted into a slot that is formed on a location on an electronic device. The SIM card 1524 includes unique identification information (such as an Integrated Circuit Card Identifier (ICCID)) or subscriber information (such as an International Mobile Subscriber Identity (IMSI)).

The memory 1530 may include an internal memory 1532 or an external memory 1534. The internal memory 1532 may include at least one of e.g., a volatile memory (such as a Dynamic Random Access Memory (DRAM), a Static RAM (SRAM), or a Synchronous Dynamic RAM (SCRAM)) and a non-volatile memory (such as an One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a NAND flash memory, or a NOR flash memory).

According to an embodiment of the present invention, the internal memory 1532 may be a Solid State Drive (SSD). The external memory 1534 may further include a flash drive, such as a Compact Flash (CF) drive, a Secure Digital (SD) drive, a micro SD (micro-SD) drive, a mini SD (mini-SD) drive, an extreme Digital (xD) drive, or a memory stick. The external memory 1534 may be functionally connected to the electronic device 1501 via various interfaces. According to an embodiment of the present invention, the electronic device 1501 may further include a storage device (or storage medium) such as a Hard Disk Drive (HDD).

The sensor module 1540 measures a physical quantity, senses the operation state of the electronic device 1501 and converts measured or sensed information into an electrical signal. The sensor module 1540 includes at least one of a gesture sensor 1540A, a gyro sensor 1540B, a pressure sensor 1540C, a magnetic sensor 1540D, an acceleration sensor 1540E, a grip sensor 1540F, a proximity sensor 1540G, a color sensor 1540H (such as a Red, Green, Blue (RGB) sensor), a bio sensor 1540I, a temperature/humidity sensor 1540J, an illumination sensor 1540K or a Ultra Violet light (UV) sensor 1540M, for example. Additionally or alternatively, the sensor module 1540 may include, for example, an Electronic nose (E-nose) sensor, an ElectroMyoGraphy (EMG) sensor, an ElectroEncephaloGram (EEG) sensor, an ElectroCardioGram (ECG) sensor, an InfraRed (IR) sensor, an iris sensor or a fingerprint sensor. The sensor module 1540 may further include a control circuit for controlling at least one sensor that is included in the sensor module 1140.

The input device 1550 may include a touch panel 1552, a (digital) pen sensor 1554, a key 1556 or an ultrasonic input device 1558. The touch panel 1552 recognizes a touch input by using at least one of a capacitive, pressure-sensitive, infrared or ultrasonic technique, for example. Also, the touch panel 1552 may further include a control circuit in the case of the capacitive technique, a physical contact or proximity awareness is possible. The touch panel 1552 may further include a tactile layer. In this case, the touch panel 1552 may provide a tactile response to a user.

The (digital) pen sensor 1554 may be implemented by using the same or similar method as that of obtaining a user's touch input or by using a separate sheet for recognition, for example. The key 1556 may include a physical button, an optical key or a keypad, for example. The ultrasonic input device 1558 is a device that senses a sound wave with the microphone 1588 of the electronic device 1501 and checks data via an input tool generating an ultrasonic signal, and the ultrasonic input device 1558 may thus perform wireless recognition. According to an embodiment of the present invention, the electronic device 1501 may also use the communication module 1520 to receive a user input from an external device (such as a computer or server) connected thereto.

The display module 1560 (such as a display 131) may include a panel 1562, a hologram device 1564 or a projector 1566. The panel 1562 may be a Liquid Crystal Display (LCD) or an Active Matrix Organic Light Emitting Diode (AM-OLED), for example. The panel 1562 may be implemented flexibly, transparently or wearably, for exampled. The panel 1562 and the touch panel 1552 may also be implemented in one module. The hologram device 1564 uses the interference of light to project a stereoscopic image into the air. The projector 1566 projects light onto a screen to display an image. The screen may be located internally or externally to the electronic device 1501, for example. According to an embodiment of the present invention, the display module 1560 may further include a control circuit for controlling the panel 1562, the hologram device 1564 or the projector 1566.

The interface 1570 may include a High Definition Multimedia Interface (HDMI) 1572, a Universal Serial Bus (USB) 1574, an optical interface 1576 or a D-subminiature (D-sub) connector 1578. Additionally or alternatively, the interface 1570 may include a Mobile High definition Link (MHL) interface, an SD card/Multi-Media Card (MMC) interface or an Infrared Data Association (IrDA) interface, for example.

The audio module 1580 converts sound into an electrical signal or vice versa. The audio module 1580 processes sound information input or output via a speaker 1582, a receiver 1584, an earphone 1586 or a microphone 1588, for example.

The camera module 1591 is a device that captures still pictures and moving pictures, and according to an embodiment of the present invention, it is possible to include one or more image sensors (such as a front sensor or rear sensor), lens, an Image Signal Processor (ISP), or a flash (e.g. an LED or a xenon lamp).

The power management module 1595 manages the electrical power of the electronic device 1501. The power management module 1595 includes a Power Management Integrated Circuit (PMIC), a charger IC, or a battery gauge, for example.

The PMIC may be included in an IC or an SoC semiconductor, for example. Charging techniques may be classified into wired and wireless techniques. The charger IC charges the battery and prevents overvoltage or overcurrent from a charger. According to an embodiment of the present invention, the charger IC may include a charger IC for at least one of a wired charging technique and a wireless charging technique. The wireless charging technique includes, for example, a magnetic resonance type, a magnetic induction type, or an electromagnetic wave type, and an additional circuit for wireless charging may be added such as a coil loop, a resonance circuit, or a rectifier.

The battery gauge measures the state, current or temperature of the battery 1596, or the voltage of the battery 1596 during charging, for example. The battery 1596 stores or generates electricity and uses stored or generated electricity to supply electrical power to the electronic device 1501. The battery 1596 may include a rechargeable battery or a solar battery, for example.

The indicator 1597 shows the specific states of the electronic device 1501 or a portion (e.g., the AP 1510) of the electronic device 1501, such as a booting state, a message state or a charged state. The motor 1598 converts an electrical signal into a mechanical vibration. The electronic device 1501 may include a processing device (e.g., a GPU) for supporting a mobile TV. The processing device for supporting the mobile TV may process media data according to a Digital Multimedia Broadcasting (DMB), Digital Video Broadcasting (DVB) or media flow standard.

The electronic device 1501 for implementing an embodiment of the present invention may include all or some of the various components shown in FIG. 15. For example, the electronic device 1501 may include the AP 1510 for initializing and controlling the first timer and second timer. In this case, the first timer and the second timer may be included as a software module in the AP 1510.

Also, the electronic device 1501 may include the communication module 1520 for externally receiving a message and a CP for controlling the communication module 1520.

The AP 1510 may perform various functions in addition to simply controlling the timers. For example, the AP 1510 may parse a received message. The AP 1510 may parse a message, analyze the sender of the message or the content of the message and provide a notification irrespective of the operations of the timers. That is, a user may set a trigger to immediately provide a notification via the interface 1570 or the input device 1550, and the AP 1510 may provide the notification when a corresponding message is received. In this case, the first timer and the second timer may be initialized simultaneously with the notification. In an alternate embodiment of the present invention, the initialization of a timer may not be performed on a notification that is provided, ignoring the timer. Accordingly, even if the cycle of a long timer is set to be sufficiently long, such as two hours or more, a user may quickly receive a notification of an important message.

The AP 1510 may provide a notification by using the speaker 1582 of the audio module 1580 or a vibrator that is included in the sensor module 1540. The power management module 1595 may check the state of the battery 1596 or whether to charge the battery so that the AP 1510 inactivates a timer or a display-type notification to avoid significant battery power consumption.

An electronic device providing a notification of an event by using a timer according to various embodiments of the present invention may include a control unit initializing a first timer and a second timer that operates to control the notification; an event sensing unit sensing the occurrence of at least one event; and a notification unit providing a notification of the event. The control unit may control the notification unit to provide a notification of at least one notification-restricted event by the second timer among events that have occurred after the initialization of the first timer, when the first timer expires.

In various embodiments of the present invention, the control unit may sense the usage state of the electronic device by a user, and when the electronic device is being used, the control unit may deactivate the first timer and the second timer.

In various embodiments of the present invention, the control unit may activate the first timer and the second timer, in at least one case of when the electrical power of the electronic device is ON (e.g. electrical power is supplied to the electronic device), when the electronic device enters a manner mode, or when the electronic device enters an etiquette mode.

In various embodiments of the present invention, the control unit may determine, based on a user input, whether to activate the first timer and the second timer. Also, the user input may be provided to a locked screen of the electronic device.

In various embodiments of the present invention, the control unit may forcibly terminate the second timer and provide a notification of an event occurring after the initialization, when the number of events occurring after the initialization exceeds a predefined reference value.

According to various embodiments of the present invention, it is possible to efficiently control a notification that is repetitively provided for a short time by an electronic device.

Also, according to various embodiments of the present invention, even if it is generally impossible to change a notification state because the electronic device is in a locked state, it is possible to restrict a notification via the activation of a timer.

According to various embodiments of the present invention, it is possible to selectively set a timer for an application that may generate repetitive notifications of messages or an application for which a user wants to restrict a notification, among various applications that the electronic device provides, thereby controlling a notification.

In addition, various methods derived via the disclosure may be provided.

Each of the above-described elements of the electronic device according to various embodiments of the present invention may include one or more components and the names of corresponding elements may vary depending on the type of an electronic device. The electronic device according to various embodiments of the present invention may include at least one of the above-described elements and some elements may be left out or other elements may be further included. Also, some of the elements of the electronic device according to various embodiments of the present invention are combined to form an entity, which may equally perform the functions of corresponding elements before being combined.

The term “module” used in various embodiments of the present invention refers to a unit including one of hardware, software and firmware, for example or a combination of two or more thereof. The “module” may be interchangeably used with the term “unit,” “logic,” “logical block,” “component,” or “circuit,” for example. The “module” may be an elementary unit, or a portion, of an integral component. The “module” may also be an elementary unit for performing one or more functions or a portion of the elementary unit. The “module” may be implemented mechanically or electronically. For example, the “module” according to various embodiments of the present invention may include at least one of an Application Specific Integrated Circuit (ASIC), a Field Programmable Gate Array (FPGA) and a programmable-logic device that perform some operations and is known or will be developed.

In addition, embodiments of the present invention disclosed in the present disclosure and the drawings only present examples to easily describe the details of various embodiments of the present invention and facilitate understanding of the present invention, and are not intended to limit the scope of the present invention. Thus, it should be construed that all changes or modified forms derived from the technical spirit of the present invention are included within the scope of the present invention, as defined by the appended claims and their equivalents.

What is claimed is:

1. A method of providing a notification by an electronic device, the method comprising:
initializing a first timer and a second timer that operate to control the notification;
sensing at least one event;
determining whether to restrict the notification of the at least one event based on a comparison of an occurrence time of the at least one event to a state of the second timer; and
when the first timer expires, providing the notification of the at least one event which occurred after the initialization of the first timer and of which the notification is restricted by the second timer.

2. The method according to claim 1, wherein a cycle of the first timer is greater than a cycle of the second timer.

3. The method according to claim 1, further comprising initializing the second timer when the at least one event occurs.

4. The method according to claim 1, further comprising initializing the first timer and the second timer when the notification is provided.

5. The method according to claim 1, wherein determining whether to restrict the notification of the at least one event comprises determining to restrict the notification of the at least one event if the second timer does not expire when the at least one event occurs, and determining to provide the notification of the at least one event if the second timer is in an expired state when the at least one event occurs.

6. The method according to claim 5, wherein determining to provide the notification of the at least one event comprises determining to provide the notification of the at least one event even before the first timer expires.

7. The method according to claim 1, further comprising providing the notification even before the first timer expires, if the at least one event satisfies a designated condition.

8. The method according to claim 7, wherein the designated condition includes at least one of a sender of the at least one event, an application related to the at least one event, and contents included in the at least one event.

9. The method according to claim 1, wherein providing the notification of the at least one event comprises arranging the at least one event occurring during an operation time of the first timer in a form of an icon on a screen.

10. The method according to claim 1, wherein determining whether to restrict the notification of the at least one event comprises:
determining to provide the notification of a designated number of at least one events occurring after the initialization of the first timer by changing an intensity of the notification; and
when the intensity of the notification is less than or equal to a reference value, determining whether to restrict the notification of the at least one event based on the comparison of the occurrence time of the at least one event to the state of the second timer.

11. The method according to claim 10, wherein the intensity of the notification includes at least one of an intensity of a vibration of the electronic device and a volume of a sound related to the at least one event.

12. The method according to claim 2, further comprising increasing the cycle of the first timer if a user input for checking the provided notification is not received within a predetermined time after providing the notification.

13. An electronic device providing a notification of at least one event, the electronic device comprising:
a control unit configured to initialize a first timer and a second timer that operate to control the notification;
an event sensing unit configured to sense an occurrence of the at least one event; and
a notification unit configured to provide the notification of the at least one event,
wherein the control unit is further configured to control the notification unit to provide the notification of at least one notification-restricted event by the second timer among the at least one event that has occurred after the initialization of the first timer, when the first timer expires.

14. The electronic device according to claim 13, wherein the control unit is further configured to sense a usage state of the electronic device and deactivate the first timer and the second timer if the electronic device is in use.

15. The electronic device according to claim 13, wherein the control unit is further configured to activate the first timer and the second timer in at least one case wherein electrical power is supplied to the electronic device, when the electronic device enters a manner mode, or when the electronic device enters an etiquette mode.

16. The electronic device according to claim 13, wherein the control unit is further configured to determine whether to activate the first timer and the second timer based on a user input.

17. The electronic device according to claim 16, wherein the user input is set to activate the first timer and the second timer while the electronic device is in a locked state.

18. The electronic device according to claim 13, wherein the control unit is further configured to terminate the second timer and provide a notification of the at least one event occurring after the initialization, when a number of at least one event occurring after the initialization exceeds a predefined reference value.

19. A method of providing a notification by an electronic device, the method comprising:
initializing a timer operating to control the notification;
sensing an occurrence of at least one event; and
if the at least one event exceeds a number of times within a designated time after the initialization of the timer, restricting the notification of the at least one event.

20. The method of claim 19, further comprising providing the notification of the at least one event for which notification is restricted when the timer expires.
